(19) United States
(12) Patent Application Publication
(10) Pub. No.: US 2022/0314416 A1
(43) Pub. Date: Oct. 6, 2022

(54) Systems and Methods for Tool Signal Extension

(71) Applicant: Milwaukee Electric Tool Corporation, Brookfield, WI (US)

(72) Inventors: Kegan Markwardt, Brookfield, WI (US); Bo Chen, Brookfield, WI (US)

(21) Appl. No.: 17/709,211

(22) Filed: Mar. 30, 2022

Related U.S. Application Data
(60) Provisional application No. 63/167,733, filed on Mar. 30, 2021.

(51) Int. Cl. B25F 5/00; H04W 4/80; G08C 17/02; H02G 1/00

(52) U.S. Cl. CPC B25F 5/00; H04W 4/80; G08C 17/02; H02G 1/005; H02G 9/02

(57) ABSTRACT

A tool system is provided that can include a tool body, a controller, and an actuator that is configured to implement a functionality. The tool system can include an extender in communication with the controller and a remote device in communication with the extender. The remote device can transmit a first signal to the extender. The extender can, in response to the first signal, transmit a second signal to the controller to cause the actuator to implement the functionality.

### RELATED APPLICATIONS

This application claims priority to U.S. Patent Application No. 63/167,733 filed Mar. 30, 2021, and entitled, “Systems and Methods for Tool Signal Extension,” which is hereby incorporated by reference in its entirety.

### BACKGROUND

Work tools, such as cutting tools, allow operators to implement various functionalities on many different components (e.g., electrical wires, power cables, sheet metal, etc.). For example, some cutting tools can include a cutting head that is driven (e.g., hydraulically, or electrically) into a component, such as a power wire, to cut through the component.

### SUMMARY

Embodiments of the invention provide a tool system including a signal extender. The tool system includes a tool body with an actuator and a controller. A power source, such as a battery, is coupled to the tool body. The tool system includes a remote device to communicate with the controller according to a wireless protocol, such as the Bluetooth wireless protocol. The tool system includes an extender to communicate with the remote device and/or the controller according to the wireless protocol. The extender receives from the remote device a first signal according to the wireless protocol. The controller causes the actuator to implement the functionality on the workpiece in response to receiving the first signal. In some embodiments, the tool system includes an extender with an antenna.

In other embodiments, the extender is removably coupled to the tool body with an electrical cable. The antenna of the extender can receive a first signal according to the wireless protocol from the remote device. The antenna of the extender can transmit the first signal to the controller of the tool body through the electrical cable.

In some embodiments, the controller operates in a first mode to wirelessly communicate directly with the remote device and in a second mode to wirelessly communicate indirectly with the remote device through the extender.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a schematic illustration of a tool system for use with some embodiments of the invention.

FIG. 2 is a schematic illustration of another tool system according to some embodiments of the invention.

FIG. 3 is a call flow diagram according to some embodiments of the invention.

FIG. 4 is a schematic illustration of another tool system according to some embodiments of the invention.

FIG. 5 is another call flow diagram according to some embodiments of the invention.

FIG. 6 is a schematic illustration of another tool system according to some embodiments of the invention.

FIG. 7 is a flowchart of a process for extending the communication distance of a tool according to some embodiments of the invention.

### DETAILED DESCRIPTION

As described above, work tools generally can implement various functionalities on different components. For example, work tools generally can include an actuator including a moveable component that when moved into contact with a component, implements some kind of functionality on the component (e.g., a workpiece). For example, such as when the work tool is implemented as a cutting tool, the actuator of the cutting tool can include a cutting head that can, when moved into contact with a component (e.g., a wire to be cut) sever the component in two. As another example, such as when the work tool is implemented as a crimping tool, the actuator of the crimping tool can include a crimping head that can, when moved into contact with a component (e.g., a wire to be crimped), crimp the component (e.g., to create an electrical connection to the wire).

Some work tools can include a controller that can control various features of the tool For example, the controller can drive extension (or rotation) of the actuator to implement a functionality on a component, or can drive retraction (or rotation in the opposing direction) of the actuator (e.g., after the functionality has been completed). In some cases, the controller of the work tool can receive sensor data, from sensors of the work tool, which can augment the control of the actuator. For example, one sensor can be a trigger that is coupled to the work tool, which when actuated (e.g., by an operator), causes the actuator to extend to implement the functionality (e.g., via the controller). In this configuration, however, typically an operator is required to be present near the location of the component in order to implement the functionality on the component (e.g., by the operator actuating the trigger). However, in some scenarios, it is not desirable to have the operator be at the location of the component. For example, when an operator is cutting a power wire that could be live with a cutting tool, there could be risks associated with being near the power wire as the power wire is being cut. As another example, the component may be situated in a location that is not easily accessible by the operator (e.g., short clearances), and thus, the operator may not be able to depress the trigger for the full duration required by the tool to implement the functionality on the component (e.g., cutting the wire).

Some embodiments of the disclosure provide advantages to these issues by providing improved systems and methods for signal extension of underground cutters or other tools. For example, some embodiments of the disclosure provide a tool system that includes a tool having an actuator configured to implement a functionality on a component, a wireless extender, and a remote device for remotely controlling the tool. The tool can be implemented in different ways. For example, the tool can be a cutting tool, a punching tool, a crimping tool, a screwdriver, a rivet tool, a ratchet, a press tool, an expander tool, etc., with each tool having an actuator with a moveable component that is configured to implement at least one functionality on a component that the tool contacts. As a more specific example, the tool can be a cutting tool that has a cutting head that can cut a wire (e.g., an example of the component). As another specific example, the tool can be a crimping tool that has a crimping head that can crimp a wire (e.g., an example of the component).

The tool can be configured to communicate according to a Bluetooth® wireless protocol with the remote device (e.g., a remote control), via the wireless extender, which can extend the total communication range, so that an operator can instruct the tool to implement the tool functionality on the component at a greater distance (e.g., as compared to the direct communication distance between the tool to the device). For example, while the Bluetooth® wireless protocol can provide advantages as compared to other wireless protocols, such as avoiding the need for other wireless infrastructures (e.g., cell towers, routers, servers, etc.), correspondingly using less power to communicate between devices (e.g., at least because there is no need to transmit to long range communication devices, such as cell towers), providing relatively fast communication speeds, and providing dependable insurance of one to one pairing between devices (e.g., that one master device is only controlling one slave device, at a time), the communication range between two devices using the Bluetooth® wireless protocol can be fairly limited. Thus, the inclusion of the wireless extender can increase the total communication range between the remote device and the tool, via the wireless extender. In this way, the operator using the remote device has more freedom to position themselves at a location that is safe, comfortable, etc., while still being able to control the tool. In other words, by the inclusion of the wireless extender, the operator is not reliant on the direct communication range between the remote control and the tool, which can not only allow for a greater total communication range between the remote control and the tool, but can also make establishing communication between the remote control and the tool easier (e.g., at least because the operator does not have to find a location that is within the direct communication range of the devices).

In some embodiments, the wireless extender can include a battery (e.g., a rechargeable battery) that powers the wireless extender. In this way, because the wireless extender has its own power source and because the wireless extender may only be used for communication, the total allowable communication distance between the remote control and the tool via the wireless extender can be larger than a doubling of the direct communication range between the remote control and the tool (e.g., because the wireless extender can partition a greater amount of power for generating a transmission signal, such as a higher amplitude signal, and can partition a greater amount of power for amplifying the signals received by the extender).

Some embodiments of the disclosure provide another tool system that can similarly provide advantages to the problems described above. For example, this tool system can include a tool having two antennas, with one coupled to the tool (e.g., located within the body of the tool) and a second antenna in wired communication with the tool. In particular, the tool can include an electrical cable for wired communication that is removably coupled to the tool at one end and coupled to the second antenna at the other end. While both the first and second antennas can transmit and receive signals according to a Bluetooth® wireless protocol, depending on a mode of operation, the tool can select which antenna to utilize during communication with a remote device (e.g., a remote control). For example, such as if the tool recognizes that the electrical cable is coupled to the tool, the tool can then utilize the second antenna for communication purposes. In this way, if an operator desires a greater communication range, the operator can interface the wire to the tool, and unravel the wire to bring the second antenna closer to the remote control to extend the total communication range between the tool and the remote control.

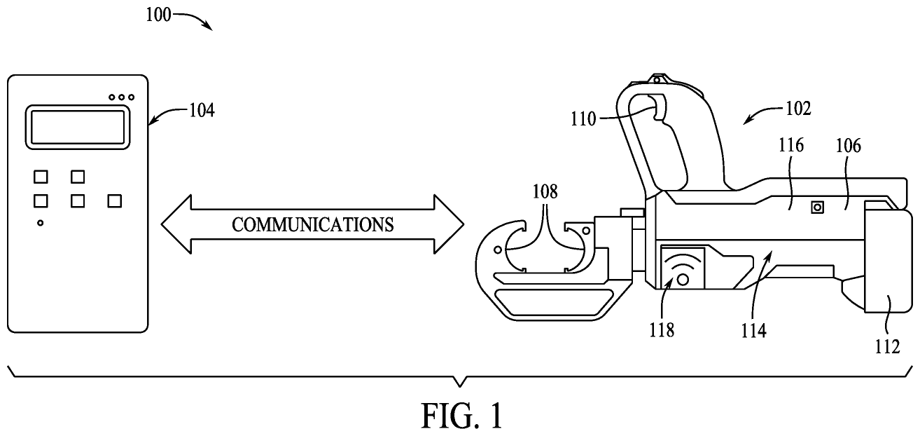

FIG. 1 shows a schematic illustration of a tool system 100. The tool system 100 can include a tool 102 and a remote device 104 configured to remotely control the tool 102. The tool 102 can include an actuator 106 and a moveable component 108 that is moveable by the actuator 106. When the moveable component is moved by the actuator 106, the moveable component 108 contacts a workpiece and implements some kind of functionality on the workpiece, or in other words, a tool operation on the workpiece. The actuator 106 can be implemented in different ways. For example, the actuator 106 can be a linear actuator that can translate the moveable component 108, or can be a rotational actuator that can rotate the moveable component 108. In some cases, the actuator 106 can be an electro-mechanical actuator (e.g., a linear actuator) that can electrically drive movement of the moveable component 108, while in other cases, the actuator 106 can be a hydraulic actuator that can hydraulically drive movement of the moveable component 108.

In one embodiment, the actuator 106 of the tool 102 can be electromechanically actuated. For example, the tool 102 can include an electric motor configured to cause a spindle to rotate, thus causing the actuator 106 coupled to the spindle to move linearly. As such, in this case, the actuator 106 can be coupled to the moveable component 108 to linearly translate the moveable component 108. In other embodiments, the actuator 106 of the tool 102 can be hydraulically actuated. For example, the tool 102 can include a motor that drives a hydraulic pump, which pressurizes hydraulic fluid and provides the pressurized fluid to the actuator 106 (e.g., a linear hydraulic cylinder). A piston of the actuator 106 can be coupled to the moveable component 108 to linearly translate the moveable component 108.

The moveable component 108 can be implemented in different ways in various embodiments. For example, the moveable component 108 can include a tool head (e.g., a cutting head, a crimping head, a pressing head, a hammer head, a ratchet head, etc.), a tool bit (e.g., a screwdriver bit), tool jaws (e.g., an expander jaw), blades (e.g., circular blades, rectangular blades, etc.), discs (e.g., a grinder disc), etc. The implementation of the functionality on the workpiece can be in various forms. For example, the functionality can be cutting, crimping, drilling, fastening (e.g., by driving of a screw, bolt, etc., into a workpiece), hammering, punching, expanding, grinding, welding (e.g., via grinding), etc. In some cases, the implementation of the functionality corresponds to the type of moveable component (e.g., how the moveable component is implemented). For example, if the tool 102 includes a cutting head as the moveable component 108, then the functionality of the tool 102 (e.g., its tool operation) can be cutting a workpiece.

In some embodiments, the tool 102 can include a trigger 110, a power source 112, a controller 114, and a body 116. The trigger 110 can be in communication with the controller 114, which can be coupled to and can be located within or onboard the body 116 of the tool 102. The trigger 110 is capable of being actuated to initiate a tool operation on a workpiece (e.g., a cutting operation). In some embodiments, the trigger 110 can be coupled to the tool 102 and physically onboard the tool 102. The tool 102 can be powered by the power source 112. In some embodiments, the power source 112 can be a battery, a rechargeable battery (e.g., a lithium-ion battery), or an electrical cord that receives power from a power outlet.

In some embodiments, the controller 114 can be configured to operate the tool 102 to implement the functionality of the tool 102 on a workpiece. For example, the controller 114 can be in communication with sensors of the tool 102, such as the trigger 110 and the actuator 106. In some cases, if the trigger 110 is actuated (e.g., pulled), the controller 114 can cause the actuator 106 to move the moveable component 108 (e.g., by directing power from the power source 112 to the actuator 106). In some embodiments, the controller 114 can cause the actuator 106 to move the moveable component 108 (e.g., to implement the functionality on the component) based on sensor inputs. Some example sensor inputs can include position sensor information indicating the position of the actuator 106, pressure sensor information indicating hydraulic pressure in chambers of a hydraulic actuator, etc.

In some embodiments, the tool 102 can include an antenna 118 that facilitates communication between the remote device 104 and the tool 102. For example, the antenna 118 can be in communication with the remote device 104 and can transmit and receive signals to and from the remote device 104. In some embodiments, the tool 102 can include other components related to computing, such as memory, other output devices (e.g., light indicators), and other input devices (e.g., actuatable buttons), etc. In some embodiments, rather than having a single antenna 118 that can both receive and transmit signals, the tool 102 can include two antennas that are each is dedicated to either transmission or receiving. For example, one antenna can only receive signals (e.g., from the remote device 104), while the other antenna can only transmit signals (e.g., to the remote device 104). In some cases, the antenna 118 can be configured to simultaneously transmit and receive signals (e.g., the antenna 118 being a transceiver). In some embodiments, the antenna 118 can be configured to receive and transmit wireless signals according to the Bluetooth® wireless protocol. Similarly, the remote device 104 can also include suitable communication devices (e.g., an antenna) that allows the remote device 104 to bi-directionally communicate with the tool 102 according to the Bluetooth® wireless protocol. In some embodiments, the tool 102 can have only a single antenna, such as the antenna 118 (e.g., where the tool 102 does not include any other antenna).

In some embodiments, the tool 102 and the remote device 104 can wirelessly communicate with each other using ultra-high frequency radio signals according to the Bluetooth® wireless protocol. For example, the ultra-high frequency radio signals can be in a frequency range between 2.4 gigahertz (GHz) and 2.485 GHz.

As shown in FIG. 1, and in some embodiments, the tool 102 is implemented as a cutting tool in which the moveable component 108 is one or more blades, such as two moveable blades. For example, the actuator 106 can cause both blades to move relative to each other to implement the functionality on the workpiece. As another example, the moveable component 108 can be implemented as one moveable blade, with the tool 102 implemented as a cutting tool having a second fixed blade. In this case, the workpiece is placed between the fixed blade and the moveable blade, and the actuator 106 causes the moveable blade to move (e.g., translate) to cut the workpiece between the two blades.

In some embodiments, the remote device 104 can be implemented in different ways. For example, the remote device 104 can include components such as a processor, memory, a display, inputs (e.g., a keyboard, a mouse, a graphical user interface, a touch-screen display, one or more actuatable buttons, etc.), communication devices (e.g., an antenna and appropriate corresponding circuitry), etc. In some embodiments, the remote device 104 can simply be implemented as a processor. In some specific embodiments, the remote device 104 can be implemented as a mobile phone (e.g., a smart phone), a personal digital assistant (“PDA”), a laptop, a notebook, a netbook computer, a tablet computing device, etc. As described below, the remote device 104 can cause the tool 102 to implement the functionality on the workpiece (e.g., via interaction with the user interface of the remote device 104).

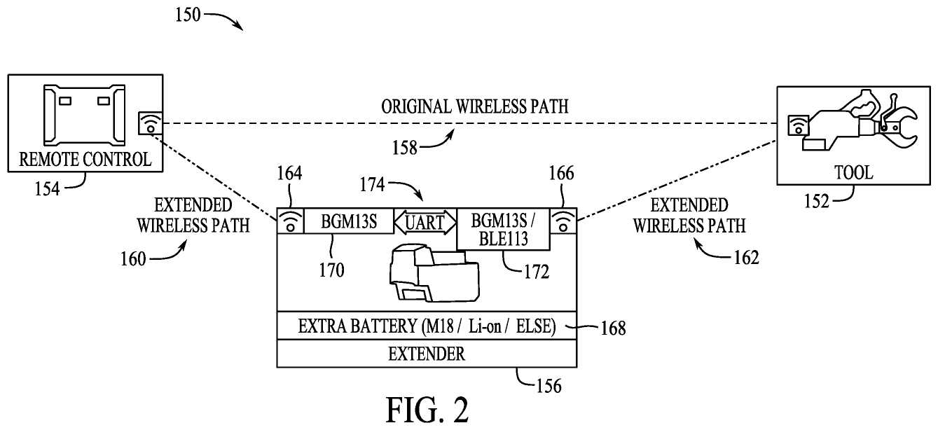

FIG. 2 shows a schematic illustration of another tool system 150, which can be a specific implementation of the tool system 100. For example, the tool system 150 can also include a tool 152 and a remote device 154 (e.g., a remote control) that is in communication (e.g., bidirectional communication) with the tool 152. In particular, the remote device 154 can be in direct wireless communication with the tool 152 using a wireless communication channel 158 (e.g., Bluetooth® wireless communication channel). In this way, the remote device 154 can directly control the tool 152 when the remote device 154 and the tool 152 communicate over the wireless communication channel 158. The tool 152 can be implemented in a similar manner as the tool 102. For example, the tool 152 can also include an actuator, a moveable component, a power source, a controller, and an antenna. In some embodiments, similarly to the tool 102, the tool 152 can include only a single antenna, such as being located within the body of the tool 152. The remote device 154 can also be implemented in a similar manner as the remote device 104. For example, the remote device 154 can also include typical computing components, such as a processor, memory, a display, inputs, communication devices, etc. As shown in FIG. 2, the tool system 150 can include an extender 156, which can be in communication (e.g., bidirectional communication) with the remote device 154 using a first wireless communication channel 160 and can be in communication (e.g., bidirectional communication) with the tool 152 using a second wireless communication channel 162.

In some embodiments, the extender 156 can include antennas 164, 166, a processor device, and a power source 168. The antennas 164, 166 can be implemented in a similar manner as the previously-described antenna 118 of the tool 102. For example, each antenna 164, 166 can at different times, transmit and receive signals, while in other cases, each antenna 164, 166 can simultaneously transmit and receive signals. In some embodiments, similarly to the antenna 118, rather than the extender 156 having only antennas 164, 166, the extender can have at least four antennas, with two being used for wireless communication with the remote device 154 and the other two being used for wireless communication with the tool 152. In this embodiment, one antenna of the first pair of antennas of the extender 156 is used for transmitting wireless signals to the remote device 154, and the other antenna of the first pair of antennas of the extender 156 is used for receiving wireless signals from the remote device 154. Similarly, one antenna of the second pair of antennas of the extender 156 is used for transmitting wireless signals to the tool 152, and the other antenna of the second pair of antennas of the extender 156 is used for receiving wireless signals from the tool 152.

In some embodiments, the extender 156 can include wireless modules 170, 172 that can both be powered by the power source 168. The wireless module 170 can include the antenna 164 (or multiple antennas as described above), while the wireless module 172 can include the antenna 166 (or multiple antennas as described above). Each of the wireless modules 170, 172 can include various electrical components that can facilitate communication using the wireless module, such as, for example, oscillators, regulators (e.g., voltage regulators), transceiver circuitry, timers, other communication interfaces (e.g., a serial interface), input and output ports, and other circuitry. In some embodiments, the wireless modules 170, 172 can each be Bluetooth® wireless modules, allowing the wireless module 170 to transmit wireless signals to and receive wireless signals from the remote device 154 over the wireless communication channel 160 according to the Bluetooth® wireless protocol. Similarly, with the wireless module 172 implemented as a Bluetooth® wireless module, the wireless module 172 can transmit wireless signals to and receive wireless signals from the tool 152 over the wireless communication channel 162 according to the Bluetooth® wireless protocol. In some specific cases, the wireless module 170 can be implemented as the BGM13S Bluetooth® wireless module (made available by Silicon Labs, Austin Tex., USA), while the wireless module 172 can be implemented as either the BGM13S Bluetooth® wireless module or the BLE113 Bluetooth® wireless module (also made available by Silicon Labs, Austin Tex., USA).

In some embodiments, the wireless modules 170, 172 can be in communication with each other over a communication channel 174, which can be a wired connection. For example, the wireless modules 170, 172 can be in serial communication with each other over the channel 174. In a more specific example, the wireless modules 170, 172 can be in communication with each other (over the channel 174) according to the universal asynchronous receiver-transmitter (“UART”) protocol (e.g., with the data format and data transmission speeds being the same between the wireless modules 170, 172). In this way, for example, data from wireless (Bluetooth®) signals received at the antenna 164 of the wireless module 170 (e.g., transmitted form the remote device 154) can be transmitted over the serial communication channel 174 to the wireless module 172. Then, after the wireless module 170 receives the data derived from the wireless signals received at the antenna 164, this data can be packaged into wireless signals that are transmitted at the antenna 166 of the wireless module 172 (e.g., to be received by the tool 152). Thus, the remote device 154 can transmit signals to the tool 152, via the extender 156. Similarly, data from the tool 152 can also be received by the remote device 154, via the extender 156. For example, data from wireless signals received at the antenna 166 of the wireless module 172 (e.g., transmitted form the tool 102) can be transmitted over the (serial) communication channel 174 to the wireless module 170. Then, after the wireless module 170 receives the data derived from the wireless signals received at the antenna 166, this data can be packaged into wireless signals that are transmitted at the antenna 164 of the wireless module 172 (e.g., to be received by the remote device 154).

In some embodiments, the communication channels 160, 162, 174 can allow the remote device 154 to bidirectionally communicate with the tool 152 via the extender 156. In this way, the remote device 154 can control the tool 152 via the extender 156 from greater distances than the distance of the wireless communication channel 158. In other words, with the extender 156 positioned between the tool 152 and the remote device 154, the combined distance of the communication channels 160, 162 (e.g., the maximum distance between respective devices while still allowing for suitable wireless communication between them) can be greater than the distance of the communication channel 158 (e.g., the maximum distance between the tool 152 and the remote device 154 while still allowing for suitable wireless commutation between each other). In some embodiments, with the extender 156, the distance between the remote device 154 and the tool 152 while still allowing for the remote device 154 to control the tool 152 can be substantially double the maximum distance (i.e., deviating by less than about plus or minus 20 percent) between the remote device 154 and the tool 152 while still allowing for the remote device 154 to control the tool 152. Thus, with the increased communication distance, an operator using the remote device 154 can have more flexibility at the particular location from which to remotely control the tool 152. Being at a more comfortable location or at an increased distance from the workpiece can be safer for the user of the tool 152.

In some embodiments, the extender 156 can include the power source 168, which can provide power to some or all of the components of the extender 156. In some embodiments, the power source 168 can be implemented in a similar manner as the power source 112 of the tool 102. For example, in some cases, the power source 168 can be implemented as a battery, a rechargeable battery (e.g., a lithium-ion battery), or an electrical cord that receives power from a power outlet. In some embodiments, the inclusion of the power source 168 of the extender 156 can allow for greater maximum transmission or receiving distances from the remote device 154 and the tool 152. For example, because the power source 168 of the extender 156 can be used solely for transmitting and receiving signals, the extender 156 can partition more power from the power source 168 to transmitting and receiving signals (e.g., by increasing the amplitude of the wireless signals when transmitting at an antenna and by increasing the amplification of signals received by the extender at an antenna). In this way, the remote device 154 can be placed at a greater distance from the extender 156, and the tool 152 can be placed at a greater distance from the extender 156, with the remote device 154 still being able to control the tool 152 via the extender 156.

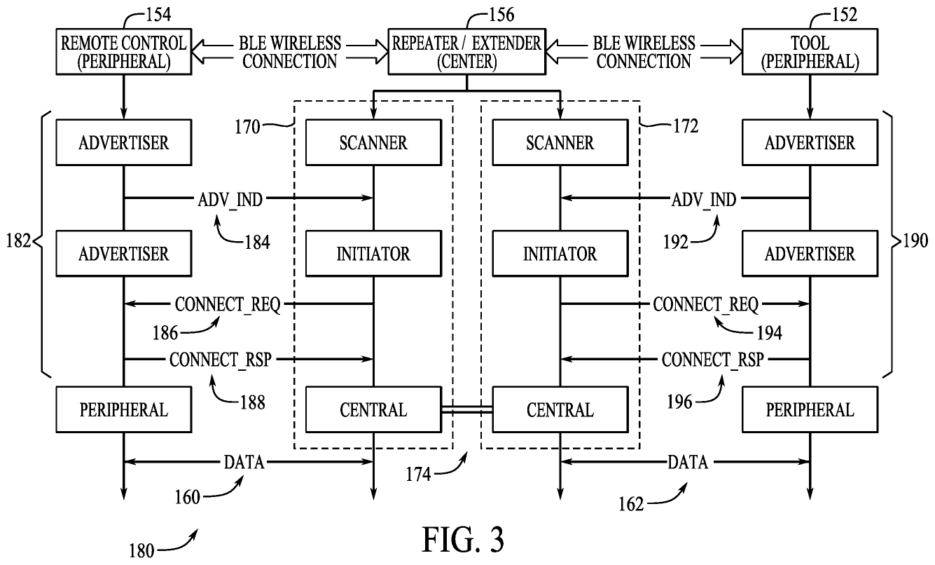

FIG. 3 shows an example of a call flow diagram 180, which describes a Bluetooth® communication protocol between the remote device 154, the extender 156, and the tool 152. In some embodiments, the wireless communication channel 160 between the remote device 154 (e.g., the remote control) and the extender 156 can be established according to the procedure of the flow diagram 180. For example, the remote device 154 and the extender 156 can implement a discovery process 182, which when successfully implemented, establishes the wireless communication channel 160 and allows data to be transmitted from the remote device 154 and to the extender 156 (and vice versa) over the wireless communication channel 160 (e.g., a Bluetooth® wireless communication channel). In particular, the remote device 154 can function as the advertiser and can transmit an advertiser message 184 (e.g., one or more data packets, such as an inquiry packet) to the wireless module 170 of the extender 156. The wireless module 170 of the extender 156 can function as the scanner, which can scan multiple channels (e.g., frequency bands) to look for an advertiser message (e.g., the advertiser message 184). When the wireless module 170 of the extender 156 receives the advertiser message 184, in response, the wireless module 170 of the extender 156 can function as the initiator and transmit to the remote device 154 a connection request message 186, which contains the information needed to establish the wireless communication channel 160. When the remote device 154 receives the connection request message 186, the remote device 154 transmits a connection response message 188 to the wireless module 170 of the extender 156, indicating to the wireless module 170 that the connection request message 186 has been appropriately received by the remote device 154. Once the wireless module 170 of the extender 156 receives the connection response message 188, the wireless communication channel 160 is established (e.g., according to the details in the connection request message 186), and data can be transmitted from the remote device 154 and to the wireless module 170 of the extender 156 (and vice versa).

In some embodiments, similarly to discovery process 182, a discovery process 190 can be implemented between the extender 156 and the tool 152 to establish the wireless communication channel 162 (e.g., a Bluetooth® communication channel) between these devices thereby allowing data to be transmitted from the extender 156 to the tool 152 (and vice versa). For example, the tool 152 can function as the advertiser and can transmit an advertiser message 192 (e.g., one or more data packets, such as an inquiry packet) to the wireless module 172 of the extender 156. The wireless module 172 of the extender 156 can function as the scanner, which can scan multiple channels (e.g., frequency bands) to look for an advertiser message (e.g., the advertiser message 192). When the wireless module 172 of the extender 156 receives the advertiser message 194, in response, the wireless module 172 of the extender 156 can function as the initiator and transmit to the tool 152 a connection request message 194, which contains the information needed to establish the wireless communication channel 162. When the tool 152 receives the connection request message 194, the remote device 154 transmits a connection response message 196 to the wireless module 172 of the extender 156 indicating to the wireless module 172 that the connection request message 194 has been appropriately received by the tool 152. Once the wireless module 172 of the extender 156 receives the connection response message 196, the wireless communication channel 162 is established (e.g., according to the details in the connection request message 194) and data can be transmitted from the tool 152 to the wireless module 172 of the extender 156 (and vice versa).

As described above, the wireless modules 170, 172 can bidirectionally communicate with each other over the communication channel 174, which can be a wired connection between the wireless modules 170, 172. In particular, the wired connection can provide a wired serial communication interface between the modules 170, 172, allowing the modules 170, 172 to serially communicate with each other (e.g., using the UART protocol). In this way, data can be transmitted from the remote device 154 to the wireless module 170 (via the communication channel 160), to the wireless module 172 (via the communication channel 174), and to the tool 152 (via the communication channel 162. Similarly, data can flow in the opposite direction with the data being transmitted from the tool 152 to the wireless module 172 (via the communication channel 162), to the wireless module 170 (via the communication channel 174), and to the remote device 154 (via the communication channel 160).

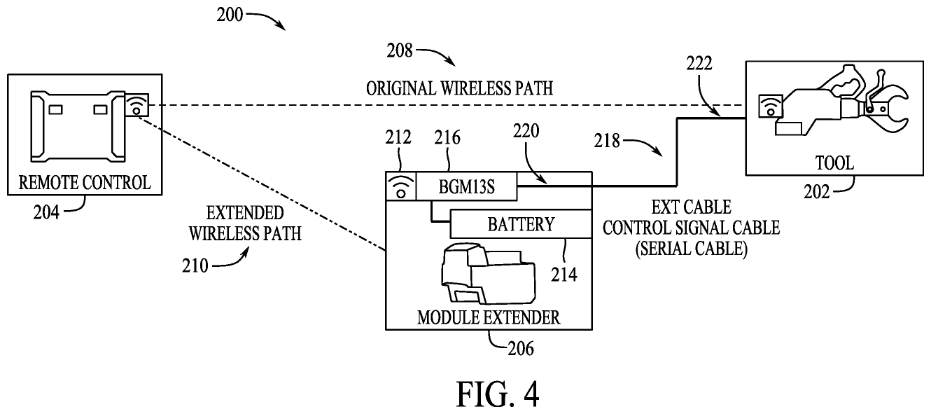

FIG. 4 shows a schematic illustration of another embodiment of a tool system 200, which can be a specific implementation of the tool system 100. For example, the tool system 200 can also include a tool 202 and a remote device 204 (e.g., a remote control) that is in communication (e.g., bidirectional communication) with the tool 202. In particular, the remote device 204 can be in direct wireless communication with the tool 202 using a wireless communication channel 208 (e.g., Bluetooth® wireless communication channel). In this way, the remote device 204 can directly control the tool 202 when the remote device 204 and the tool 202 communicate over the wireless communication channel 208.

In some embodiments, the tool 202 can be implemented in a similar manner as the tool 102 or the tool 152. For example, the tool 202 can also include an actuator, a moveable component, a power source, a controller, and an antenna. In some embodiments, similarly to the tool 102, the tool 202 can have only a single antenna, such as one located within the body of the tool 202, while in other case the tool 202 does not include an antenna coupled to or within the body of the tool 202 (except for the antenna 212 of the extender 206). In some embodiments, the remote device 204 can also be implemented in a similar manner as the remote device 104 and the remote device 154. For example, the remote device 204 can also include typical computing components, such as a processor, memory, a display, inputs, communication devices, etc.

As shown in FIG. 4, and similar to the tool system 150, the tool system 200 can include an extender 206, which can be in communication (e.g., bidirectional communication) with the remote device 204 using a wireless communication channel 210 (e.g., a Bluetooth® wireless communication channel). For example, the extender 206 can include an antenna 212, a processor device (not shown), and a power source 214. The antenna 212 can be implemented in a similar manner as the previously-described antenna 118 of the tool 102 or the antennas 164, 166 of the extender 156. For example, the antenna 212 can at different times, transmit and receive signals, while in other embodiments, the antenna 212 can simultaneously transmit and receive signals. In some embodiments, rather than the extender 206 having only the antenna 212, the extender can have at least two antennas, with one antenna being used for receiving wireless signals from the remote device 204 and with another antenna being used for transmitting wireless signals to the remote device 204.

In some embodiments, similarly to the extender 156, the extender 206 can include a wireless module 216, which can be powered by the power source 214. In some embodiments, the wireless module 216 can include the antenna 212 (or multiple antennas as described above), and various electrical components that can facilitate communication using the module, such as, for example, oscillators, regulators (e.g., voltage regulators), transceiver circuitry, timers, other communication interfaces (e.g., a serial interface), input and output ports, and other circuitry. In some embodiments, the wireless module 216 can be a Bluetooth® wireless module, allowing the wireless module 216 to transmit wireless signals to and receive wireless signals from the remote device 204 over the wireless communication channel 210 according to the Bluetooth® wireless protocol. In some specific embodiments, the wireless module 210 can be implemented as the BGM13S Bluetooth® wireless module (made available by Silicon Labs, Austin Tex., USA). In other configurations, rather than the tool 202 and the extender 206 each having their own wireless modules, the extender 206 can electrically connect to the controller of the tool 202. In this case, the tool 202 does not have (and does not need) its own wireless module (e.g., and thus the tool 202 cannot communicate directly with the remote control 204).

As shown in FIG. 4, the extender 206 of the tool system 200 has a different configuration than the extender 156 of the tool system 150. For example, the tool system 200 (either the extender 206 or the tool 202) includes an electrical cable 218 that can be removably coupled to the extender 206 and the tool 202. In particular, when the electrical cable 218 is coupled to the extender 206, the electrical cable 218 electrically connects to the extender 206. Correspondingly, when the electrical cable 218 is coupled to the tool 202 (e.g., the body of the tool 202), the electrical cable 218 electrically connects to the extender 206. In a similar manner, when the electrical cable 218 is decoupled from the extender 206, the electrical cable 218 electrically disconnects from the extender 206, while when the electrical cable 218 is decoupled from the tool 202, the electrical cable 218 electrically disconnects from the extender 206.

In some embodiments, the electrical cable 218 has opposing ends 220, 222. The end 220 of the electrical cable 218 is electrically connected to the extender 206, while the end 222 is electrically connected to the tool 202. When both ends 220, 222 of the electrical cable 218 are connected, a wired connection is established between the extender 206 and the tool 202 (e.g., the controller of the tool 202), which allows bidirectional wired communication between these devices (e.g., serial communication). In some cases, each of the ends 220, 222 of the electrical cable 218 can have a connector that interfaces with a corresponding connector on the respective device. For example, a connector (e.g., a male type connector) of the end 220 interfaces with a connector (e.g., a female type connector) of the extender 206, while a connector (e.g., a male type connector) of the end 222 interfaces with a connector (e.g., a female type connector) of the tool 202. In some embodiments, each connection of the tool 202 and the extender 206 can be an electrical port that selectively engages and disengages with the respective end 222, 220 of the electrical cable 218.

Regardless of the configuration of the electrical cable 218, both ends 220, 222 can be removably coupled to their respective device. For example, the end 220 can be removably coupled to the extender 206, while the end 222 can be removably coupled to the tool 202. In this way, if signal extension is not needed, the electrical cable 218 can be disconnected from the tool 202 (and the extender 206), so the tool 202 can implement its functionality (e.g., by actuating the trigger of the tool 202), or such as when the tool 202 includes its own wireless module, can communicate with the remote device 204 directly over the wireless communication channel 208. When signal extension is desired, the electrical cable 218 can be electrically connected to the extender 206 and the tool 202, so the remote device 204 can communicate with the tool 202 via the extender 206. The removably-coupled configuration of the electrical cable 218 can ensure that the electrical cable 218 is only present when it is needed, decreasing the bulkiness of connection if signal extension is not needed. In some embodiments, the electrical cable 218 can be a coaxial cable.

In some embodiments, and similar to the tool system 150, the inclusion of the extender 206 allows the remote device 204 to bidirectionally communicate with the tool 202 via the extender 206 over larger distances than the maximum allowable communication distance between the remote device 204 and the tool 202 over the direct wireless communication channel 208. In other words, with the extender 206 positioned between the tool 202 and the remote device 204, the combined distance of the communication channel 210 (e.g., the maximum distance between the remote device 204 and the extender 206 while still allowing for suitable wireless communication between them) and the electrical cable 218 (e.g., in an unraveled and extended state) can be greater than the maximum allowable communication distance provided by the direct wireless communication channel 208. Thus, with the increased communication distance, an operator with the remote device 204 can have more flexibility at the particular location to remotely control the tool 202. Being at a more comfortable location and at an increased distance from the workpiece can be safer for the user.

In some embodiments, the extender 206 can include the power source 214, which can provide power to some or all of the components of the extender 206. In some cases, the power source 214 can be implemented in a similar manner as the power source 112 of the tool 102, the power source of the tool 152, or the power source 168 of the extender 156. For example, in some embodiments, the power source 214 can be implemented as a battery, a rechargeable battery (e.g., a lithium-ion battery), or an electrical cord that receives power from a power outlet. In some embodiments, the inclusion of the power source 214 of the extender 206 can allow for greater maximum transmission or receiving distances from the remote device 204 and the tool 202. For example, because the power source 214 of the extender 206 can be used solely for transmitting and receiving signals, the extender 206 can partition more power from the power source 214 to transmitting and receiving signals (e.g., by increasing the amplitude of the wireless signals when transmitting at an antenna and by increasing the amplification of signals received by the extender at an antenna). In this way, the remote device 204 can be placed at a greater distance from the extender 206, and the tool 202 can be placed at a greater distance from the extender 206, with the remote device 204 still being able to control the tool 202 via the extender 206.

In some embodiments, the remote device 204 (e.g., the remote control) can control the tool 202 via the extender 206 (e.g., once the communication channels are established). For example, with the electrical cable 218 connected to both the extender 206 and the tool 202, the extender 206 can be positioned between the remote device 204 and the tool 202 and can be moved away from the tool 202 (e.g., to unravel and extend the electrical cable 218). In this way, the distance between the remote device 204 and the tool 202 can be increased, while the distance between the remote device 204 and the extender 206 can be correspondingly increased or can be maintained. Once the communication channels have been established, and in particular, the wireless communication channel 210 has been established between the remote device 204 and the extender 206 (e.g., because the electrical cable 218 is already connected to the extender 206 and the tool 202, and thus wired communication between these devices is already established), data can flow bidirectionally between the remote device 204 and the tool 202 via the extender 206. In particular, data can be packaged by the remote device 204 and transmitted as wireless signals (e.g., by an antenna of the remote device 204) to the extender 206 over the communication channel 210. The extender 206, and in particular the antenna 212 of the wireless module 216, can receive the wireless signals from the remote device 204, can extract the data from the wireless signals, and transmit the data along the electrical cable 218 (e.g., serially) to be received by the tool 202. Similarly, data can also flow in the opposite direction from the tool 202 and to the remote device 204 via the extender 206. For example, data can be packaged by the tool 202 to be (serially) transmitted along the electrical cable 218 to the wireless module 216 of the extender 206. Then, the wireless module 216 can package the data into wireless signals that are transmitted by the antenna 212 to be received by the remote device 204.

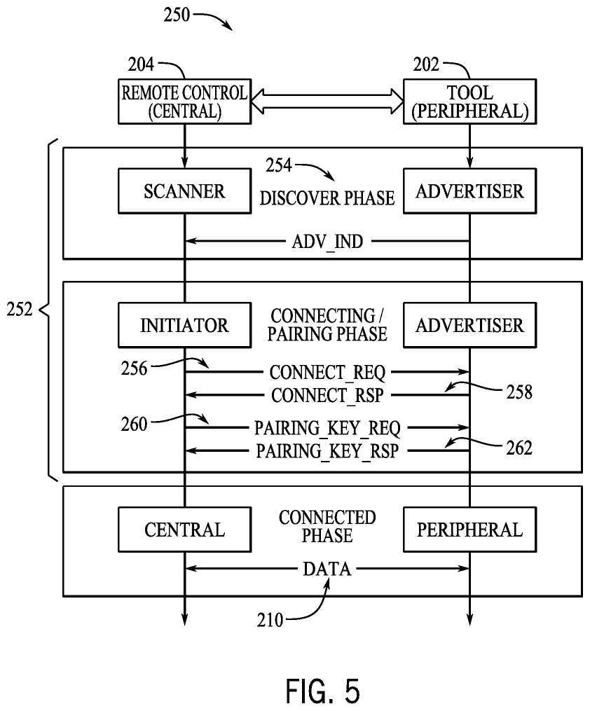

FIG. 5 shows an example of a call flow diagram 250, which describes a Bluetooth® communication protocol between the remote device 204 and the tool 202 with the extender 206 acting as an intermediary between the two devices. In some embodiments, the call flow diagram 250 details a procedure for establishing the wireless communication channel 210 (e.g., a Bluetooth® wireless communication channel). For example, the remote device 204 (and the tool 202 via the extender 206) can implement a discovery process 252, which when successfully implemented, allows data to be transmitted from the remote device 204 and to the tool 202 (and vice versa) via the extender 206 over the wireless communication channel 210. In particular, the tool 202 can function as the advertiser and can transmit an advertiser message 254 (e.g., one or more data packets, such as an inquiry packet) to the remote device 204. In some embodiments, this can include the tool 202 packaging and transmitting the advertiser message 254 over the electrical cable 218 (e.g., serially) to the wireless module 216 of the extender 206, where it is packaged into wireless signals and is transmitted to the remote device 204 (e.g., by the antenna 212). The remote device 204 can function as the scanner, which can scan multiple channels (e.g., frequency bands) to look for an advertiser message (e.g., the advertiser message 254). When the remote device 204 receives the advertiser message 254, in response, the remote device 204 can function as the initiator and transmit to the tool 102 a connection request message 256, which contains the information needed to establish the wireless communication channel 210. In some embodiments, this can include wireless signals that define the advertiser message 254 being received at the antenna 212 of the wireless module 216 of the extender 206, and the wireless module 216 subsequently transmitting the connection request message 256 over the electrical cable to be received by the tool 202 (e.g., serially).

In some embodiments, when the tool 202 receives the connection request message 256, the tool 202 transmits a connection response message 258 to the remote device 204 (e.g., in a similar manner as how the advertiser message 254 was transmitted), indicating to the remote device 204 that the connection request message 256 has been appropriately received by the remote device 204. Once the remote device 204 receives the connection response message 258, the remote device 204 can transmit to the tool 202 a key request message 260, which requests that the communication channel between the remote device 204 and the tool 202 via the extender 206 be encrypted (e.g., the wireless communication channel 210), and which contains the details for encrypting the communication channel. When the tool 202 receives the key request message 260 (e.g., in a similar manner as how the tool 202 received the connection request message 256), in response, the tool 202 can transmit a key response message 262 to the remote device 204 (e.g., in a similar manner as how the tool 202 transmitted the advertiser message 254). The key response message 262, when received by the remote device 204, indicates to the remote device 204 that the tool 202 has received the key request message 260, and thus has received the necessary details for encrypting the communication channel (e.g., the encryption key for how the data is encrypted to extract the data). Once the remote device 204 receives the key response message 262, the wireless communication channel 210 between the remote device 204 and the tool 202 (via the extender 206) can be established (e.g., according to the details in the connection request message 256) and encrypted (e.g., according to the details in the key request message 260). In this way, data can flow bidirectionally over the wireless communication channel 210 from the remote device 204 to the tool 202 (and vice versa), allowing the remote device 204 to control the tool 202 via the extender 206.

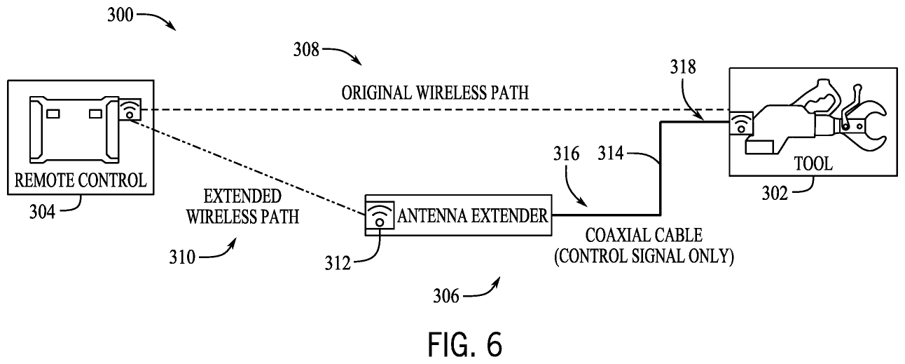

FIG. 6 shows a schematic illustration of another tool system 300, which can be a specific implementation of the tool system 100. For example, the tool system 300 can also include a tool 302 and a remote device 304 (e.g., a remote control) that is in communication (e.g., bidirectional communication) with the tool 302. In particular, the remote device 304 can be in direct wireless communication with the tool 302 using a wireless communication channel 308 (e.g., Bluetooth® wireless communication channel). In this way, the remote device 304 can directly control the tool 302 when the remote device 304 and the tool 302 communicate over the wireless communication channel 308.

In some embodiments, the tool 302 can be implemented in a similar manner as the tool 102 or the tools 152, 202. For example, the tool 302 can also include an actuator, a moveable component, a power source, a controller, and an antenna. In some embodiments, similarly to the tool 102, the tool 302 can have only a single antenna, such as located within the body of the tool 302, while in other cases the tool 302 does not include an antenna coupled to or within the body of the tool 302 (except for the antenna 312 of the extender 306). In some embodiments, the remote device 304 can also be implemented in a similar manner as the remote device 104 and the devices 154, 204. For example, the remote device 304 can also include typical computing components, such as a processor, memory, a display, inputs, communication devices, etc.

As shown in FIG. 6, the tool system 300 can include an extender 306 (e.g., an antenna extender), which can be removably coupled to the tool 302 and can be in communication (e.g., bidirectional communication) with the remote device 304 using a wireless communication channel 310 (e.g., a Bluetooth® wireless communication channel). The extender 306 can include an antenna 312 and an electrical cable 314. The antenna 312 can be implemented in a similar manner as the previously described antenna 118 of the tool 102 or the antennas 164, 166 of the extender 156 or the antenna 212 of the extender 206. For example, the antenna 312 can at different times, transmit and receive signals, while in other embodiments, the antenna 312 can simultaneously transmit and receive signals. In some embodiments, rather than the extender 306 having only the antenna 312, the extender 306 can have at least two antennas, with one antenna being used for receiving wireless signals from the remote device 304, and with another antenna being used for transmitting wireless signals to the remote device 304.

As shown in FIG. 6, similar to the extender 206, the extender 306 of the tool system includes an electrical cable 314 that has opposing ends 316, 318. The end 316 of the electrical cable 314 is electrically connected to the antenna 312, while the end 318 is electrically connected to the tool 302 (e.g., a wireless module, such as a Bluetooth® wireless module). When both ends 316, 318 of the electrical cable 314 are connected, a wired connection is established between the antenna 312 of the extender 306 and the tool 302. In some configurations, the antenna 312 can be electrically connected as an input to the tool 302, so that the controller of the tool 302 can transmit and receive messages using the antenna 312. In some embodiments, the end 318 of the electrical cable 314 can be removably coupled to the tool 302 and the end 316 of the electrical cable 314 can be removably coupled to the antenna 312. In some embodiments, the end 316 of the electrical cable 314 can be coupled to the antenna 312. In this way, when signal extension is desired, only the end 318 of the electrical cable 314 needs to be interfaced with the tool 302.

In some embodiments, similar to the extender 206, each of the ends 316, 318 of the electrical cable 314 can have a connector that interfaces with a corresponding connector on the respective device. For example, a connector (e.g., a male type connector) of the end 316 interfaces with a connector (e.g., a female type connector) of the body of (or that includes) the antenna 312, while a connector (e.g., a male type connector) of the end 318 interfaces with a connector (e.g., a female type connector) of the tool 302. In some embodiments, each connection of the tool 302 and the body of the antenna 312 can be an electrical port that selectively engages and disengages with the respective end 316, 318 of the electrical cable 314. In some embodiments, the electrical cable 314 can be a coaxial cable.

In some embodiments, the extender 306 does not include a power source (e.g., a battery, a rechargeable battery). For example, the extender 306 can leverage the power source of the tool 302 to wirelessly transmit signals between the extender 306 and the remote device 304. In this way, when the extender 306 is electrically connected to the tool 302, the power source of the tool 302 can electrically connect to the extender 306. For example, when the antenna 312 is part of a wireless module (e.g., a Bluetooth® wireless module), and when the electrical cable 314 is electrically connected to the wireless module, the wireless module electrically connects to the power source of the tool, so that, for example, the power source of the tool supplies power to the wireless module. In this way, the controller of the tool, which can also be electrically connected to the wireless module that includes the antenna 312 when the electrical cable 314 is electrically connected to the power tool, can transmit a signal (e.g., a control signal, a digital signal, etc.) to the wireless module over a wired connection to cause the wireless module to emit a wireless signal at the antenna 312. Thus, the signal (e.g., a digital signal, not an RF signal, not an analog signal, etc.) may be less prone to signal losses when propagated along the electrical wire. Accordingly, the wireless signal emitted at the antenna 312 may be stronger than if an analog signal (e.g., an RF signal) propagated through the electrical cable to the antenna 312. Correspondingly, the controller of the tool can receive a signal (e.g., a digital signal) from the wireless module (e.g., that includes the antenna 312) over the wired connection provided by the electrical cable 314 (e.g., to cause the tool 302 to implement a functionality on a workpiece).

In some configurations, the antenna 312 of the extender 306 does not include a wireless module. In other words, the antenna 312 is not part of a wireless module. In this case, an RF signal can be emitted by the tool, can propagate along the electrical cable 314 to the antenna 312, and can be emitted by the antenna 312 as a wireless RF signal. For example, when the electrical cable 314 electrically connects to the tool 302, the antenna 312 can electrically connect to the tool 302 (e.g., the controller of the tool). In this way, the controller of the tool 302 can transmit a signal to the antenna 312, via the electrical cable 314. Correspondingly, the tool (e.g., the controller of the tool) can receive a signal (e.g., an analog signal, an RF signal, etc.) from the antenna 312 over the wired connection provided by the electrical cable 314 (e.g., to cause the tool 302 to implement a functionality on a workpiece). In some embodiments, the inclusion of the extender 306 allows the remote device 304 to bidirectionally communicate with the tool 302 via the extender 306 over larger distances than the maximum allowable communication distance between the remote device 304 and the tool 302 over the direct wireless communication channel 308. In other words, with the extender 306, and in particular the antenna 312, positioned between the tool 302 and the remote device 304, the length of the electrical cable 314 provides the increase in allowable distance between the remote device 304 and the tool 302 while still allowing the remote device 304 to control the tool 302. For example, the distance between the remote device 304 and the antenna 312 of the extender 306 can be substantially similar to the maximum allowable distance of the direct wireless communication channel 308. However, the length of the wired connection between the antenna 312 and the tool 302 provided by the electrical cable 314, increases the total allowable communication distance between the remote device 304 and the tool 302.

In some embodiments, the remote device 304 (e.g., the remote control) can control the tool 302 via the extender 306 (e.g., once the communication channels are established). For example, with the electrical cable 314 connected to the tool 302 and the antenna 312, the antenna 312 can be positioned between the remote device 304 and the tool 302 and can be moved away from the tool 302 (e.g., to unravel and extend the cable 314). In this way, the distance between the remote device 304 and the tool 302 can be increased, while the distance between the remote device 304 and the antenna 312 can be maximized or can be maintained. Once the wireless communication channel 310 has been established, data can flow bidirectionally between the remote device 304 and the tool 302 via the extender 306. In particular, data can be packaged by the remote device 304 and transmitted as wireless signals (e.g., by an antenna of the remote device 304) to be received by the antenna 312 of the extender 306, and thereby electrically transmit the data to the tool 302 over the electrical cable 314. Similarly, data can also flow in the opposing direction, from the tool 302 and to the remote device 304 via the extender 306. For example, data can be packaged by the tool 302 to be transmitted along the electrical cable 314 to the antenna 312 of the extender 306, where the data is transmitted from the antenna 312 as wireless signals over the wireless communication channel 310 to the remote device 304.

In some embodiments, the call flow diagram 250 that describes the Bluetooth® communication protocol between the remote device 204 and the tool 202 can also be used to establish and encrypt the communication channel 310 between the remote device 304 and the tool 302 via the extender 306. In this embodiment, the tool 302 can be the peripheral device, acting as the advertiser, while the remote device 304 can be the central device, acting as the scanner.

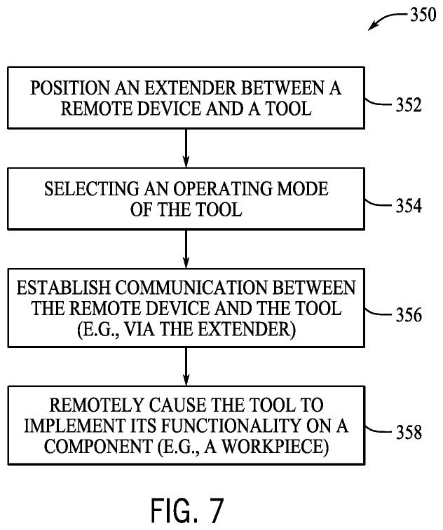

FIG. 7 shows a flowchart of a process 350 for extending the communication distance of a tool, which can be implemented using any of the previously described tool systems (e.g., the tool systems 150, 200, 300). Some or all of the blocks of process 350 can be implemented, as appropriate, using one or more devices.

At 352, the process 350 can include positioning an extender between a remote device (e.g., a remote control) and a tool. For example, this can include positioning an antenna of the extender between the remote device and the tool. In some cases, this can include turning the remote device on, turning the tool on, and turning the extender on (e.g., such as when the extender includes a power source, such as the extenders 156, 206). In some embodiments, this can include electrically connecting the extender to the tool (e.g., electrically connecting an electrical cable of the extender to the tool).

At 354, the process 350 can include one or more devices selecting an operating mode of the tool. For example, the tool can operate in at least two communication modes, with one communication mode being direct communication between the remote device (e.g., the remote control) and the tool and with the other communication mode being indirect communication between the remote device and the remote control, via the extender. In some embodiments, the one or more devices can receive a user input that can select which of these two communication modes the tool should operate in. For example, this can include the controller of the tool receiving the user input, or the tool receiving a message indicative of a user input received by the remote device (e.g., the remote control), such as when a communication channel has been previously established. In some embodiments, once the tool receives an instruction to utilize one communication mode, the tool can temporarily disable the other communication modes. For example, when the tool selects an indirect communication mode (e.g., a communication mode that utilizes the extender), the tool can disable the direct communication mode (e.g., the communication mode that only utilizes the remote device and the tool and does not utilize the extender). In other words, the tool can disable direct wireless communication channel between the remote device (e.g., the remote control) and the tool. As another example, when the tool selects the direct communication mode that does not utilize the extender, the tool can disable the indirect communication mode that utilizes the extender. In this way, the tool (and the other devices) do not waste power, time, etc., in search of a communication configuration that is not desired to be used.

In some embodiments, the communication operating mode of the tool can be automatically switched or selected. For example, if the tool or the remote device does not receive a signal within a certain period of time (e.g. 30 seconds), the tool can switch from the direct communication mode to the indirect communication mode. In this way, the tool can be preferential to the direct communication mode (e.g., which may be faster than the indirect communication mode), but when the direct communication mode is insufficient to provide an adequate communication channel (e.g., the devices are too far apart), the tool can quickly switch to the indirect communication mode. In some embodiments, the tool can automatically select its communication operating mode. For example, if the tool (e.g., the controller of the tool) senses that an electrical cable (e.g., the electrical cable 218, 314) has been electrically connected to the tool, the tool can set the communication operating mode to the indirect communication and disable the direct communication. As another example, if the tool does not sense that the electrical cable has been electrical connected to itself, the tool can set the communication operating mode to the direct communication and disable the indirect communication.

At 356, the process 350 can include the one or more devices establishing communication between the remote device (e.g., the remote control) and the tool (e.g., via the extender). In some cases, this can include establishing a wireless communication channel (according to a Bluetooth® wireless protocol) between the remote device (e.g., the remote control) and the extender, while in other cases, this can include establishing a wireless communication channel (according to a Bluetooth® wireless protocol) between the remote device and the tool. In some embodiments, this can also include establishing a wireless communication channel (according to a Bluetooth® wireless protocol) between the extender and the tool. In other embodiments, such as when the tool is operating in the direct communication mode, the tool or the remote device can establish a direct wireless communication channel with the remote device or the tool. In some configurations, the one or more devices can establish the communication channels, using any of the processes described above, such as the call flow diagrams 180, 250.

At 358, the process 350 can include the one or more devices remotely causing the tool (e.g., the actuator of the tool) to implement its functionality on a component such as a workpiece (e.g., situated in the path of the moveable component of the tool). In some configurations, such as when the tool is operating in the indirect communications mode, the remote device (e.g., the remote control) can cause the tool to implement its functionality on the workpiece, via the extender. For example, the remote device can cause the extender to transmit a message that when received by the tool causes the tool to implement its functionality on the workpiece. In other embodiments, such as when the tool is operating in the direct communications mode, the remote device can cause the tool to implement its functionality directly (e.g., when the tool receives the message from the remote device instructing it to implement its functionality on the workpiece).

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, aspects of the disclosure, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g. “one or the other but not both”) when preceded by terms of exclusivity, such as “either,” “one of,” “only one of” or “exactly one of.”

Various features and advantages of the disclosure are set forth in the following claims.

1. A tool system to implement functionality on a workpiece, the tool system comprising:
a tool body including an actuator and a controller;
a power source coupled to the tool body;
a remote device to communicate with the controller according to a Bluetooth wireless protocol; and
an extender to communicate with at least one of the remote device or the controller according to the Bluetooth wireless protocol;
the extender receiving from the remote device a first signal according to the Bluetooth wireless protocol;
the controller causing the actuator to implement the functionality on the workpiece in response to receiving the first signal.

2. The tool system of claim 1, wherein the extender is a wired extender, the wired extender including:
an electrical cable; and
an antenna electrically connected to the electrical cable,
wherein the electrical cable is configured to be coupled to the tool body to electrically connect the antenna to the controller;
wherein the remote device is in wireless communication with the extender via the antenna.

3. The tool system of claim 2, wherein the extender includes a wireless module that includes the antenna;
wherein when the electrical cable is connected to the tool body, a wired communication link is established between the controller and the wireless module;
wherein when the electrical cable electrically connects to the tool body, the power source provides power to the wireless module;
wherein the extender does not include a power source.

4. The tool system of claim 3, wherein the controller is configured to:
receive, using the wired communication link, the first signal from the extender, the first signal being a digital signal;
in response to receiving the first signal, cause the actuator to implement the functionality on the workpiece; and
transmit a second signal to the wireless module, via the electrical cable;
wherein in response to receiving the second signal, the extender transmits a wireless signal to the remote device, via the antenna.

5. The tool system of claim 2, wherein the controller is configured to:
receive, using the wired communication link, the first signal from the extender, the first signal being an analog signal; and
in response to receiving the first signal, cause the actuator to implement the functionality on the workpiece.

6. The tool system of claim 5, wherein the controller is configured to transmit a second signal to the wireless module of the extender, via the electrical cable, the second signal being an analog signal; and
wherein in response to receiving the second signal, the extender is configured to transmit a wireless signal to the remote device, via the antenna.

7. The tool system of claim 2, wherein the tool body does not include an antenna; and
wherein the controller is incapable of communicating wirelessly without the antenna of the extender.

8. The tool system of claim 1, wherein the tool body includes a first antenna, and wherein the extender is a wireless extender, the wireless extender including a second antenna; and
wherein the extender is configured to be in wireless communication with at least one of the remote device or the tool body, via the second antenna.

9. The tool system of claim 8, wherein the extender includes a third antenna, and
wherein the extender is configured to be in wireless communication with the remote device, via the second antenna; and
wherein the extender is configured to be in wireless communication with the tool body, via the third antenna.

10. The tool system of claim 9, wherein the extender includes a first wireless module that includes the second antenna, and a second wireless module that includes the third antenna;
wherein the first wireless module is electrically connected to the second wireless module; and
wherein the first wireless module is in wired communication with the second wireless module.

11. A tool system configured to implement a functionality on a workpiece, the tool system comprising:
a tool body including an actuator and a controller;
a power source coupled to the tool body;
a remote device configured to communicate with the controller according to a wireless protocol; and
an extender including an antenna;
the extender removably coupled to the tool body with an electrical cable;
the antenna receiving a first signal according to the wireless protocol from the remote device;
the extender communicating the first signal to the controller; and
the controller causing the actuator to implement the functionality on the workpiece in response to the first signal.

12. The tool system of claim 11, wherein the extender includes a wireless module that includes the antenna, the wireless module and the controller being in digital wired communication.

13. The tool system of claim 11, wherein the controller is configured to transmit and receive an analog signal that is a radiofrequency signal to the antenna through the electrical cable.

14. The tool system of claim 11, wherein the power source is a first power source, and the extender includes a second power source that is a rechargeable battery.

15. The tool of claim 11, and further comprising a second antenna coupled to the tool body, the second antenna wirelessly communicating with the remote device.

16. The tool of claim 11, wherein the workpiece is an underground wire and the functionality performed on the workpiece is cutting the underground wire; and wherein the extender is configured to be positioned above ground.

17. A tool system configured to implement a functionality on a workpiece, the tool system comprising:
a tool body including an actuator, a controller, and a first antenna;
a power source coupled to the tool body; and
a remote device configured to communicate with the controller according to a wireless protocol;
the controller operating in a first mode to wirelessly communicate directly with the remote device;
the controller operating in a second mode to wirelessly communicate indirectly with the remote device through an extender.

18. The tool system of claim 17, and further comprising a trigger in communication with the controller; and wherein the controller operates in a third mode to cause the actuator to implement the functionality on the workpiece based on the trigger being actuated.

19. The tool system of claim 18, wherein the controller operates in a single mode at any given time.

20. The tool system of claim 17, wherein the controller determines that the extender is in wireless communication and causes the tool body to operate in the second mode.

21. The tool system of claim 20, wherein the controller determines that an electrical cable is connected between the extender and the tool body and causes the tool body to operate in the second mode.
